(19) United States
(12) Patent Application Publication
(10) Pub. No.: US 2025/0091728 A1
(43) Pub. Date: Mar. 20, 2025

(54) Drone Landing Stations and Methods of Deploying Drone Landing Stations

(71) Applicant: VALQARI HOLDINGS, LLC, Batavia, IL (US)

(72) Inventors: Ryan Walsh, Aurora, IL (US); Charles Calvin Byers, Wheaton, IL (US); Stefan Prokuski, Rolling Meadows, IL (US); David Laczak, Chicago, IL (US); Geoffrey Forrest Graves, Bangkok (TH); Sean McShane, Orland Park, IL (US)

(21) Appl. No.: 18/962,305

(22) Filed: Nov. 27, 2024

Related U.S. Application Data
(63) Continuation of application No. PCT/US2023/067490, filed on May 25, 2023.
(60) Provisional application No. 63/346,464, filed on May 27, 2022.

(51) Int. Cl. B64F 1/36; B63B 35/28; B64U 10/13; B64U 70/90

(52) U.S. Cl. CPC B64F 1/368; B64U 70/90; B63B 35/28; B64U 10/13

(57) ABSTRACT

A landing station can include a package manipulation system, an anchoring system, a climate control system, and/or a convertible storage locker. In some embodiments, a temperature control carrier is used with the landing station. In some embodiments, the package manipulation system includes at least one manipulation rail, at least one finger and/or a set of projections configured to raise and lower from said landing surface. In some embodiments, the landing station includes an elevator. In some embodiments, the landing station includes a lifting ring. In some embodiments, the landing station includes an air curtain blower.

### CROSS-REFERENCE TO RELATED APPLICATION(S)

This application is a continuation of and claims priority benefits of International Application PCT/US2023/067490 entitled “Drone Landing Stations and Methods of Deploying Drone Landing Stations” having a filing date of May 25, 2023. The '490 application is related to and claims priority benefits from U.S. Provisional Application Ser. No. 63/346,464 filed on May 27, 2022, also entitled “Drone Landing Stations and Methods of Deploying Drone Landing Stations”. This application also claims priority to the '464 application.

The '490 and '464 applications are each hereby incorporated by reference herein in their entireties.

### FIELD OF THE INVENTION

The present invention relates to the use of landing stations to send and receive packages via unmanned air aerial vehicles. In some embodiments, the invention relates to landing stations configured to accept packages of various sizes and weights and methods of employing the same. In some embodiments, the invention relates to systems and methods for deploying the landing stations. In some embodiments, the invention relates to climate-controlled landing stations and methods of employing the same.

Online or remote shopping has grown immensely over the past decade. Remote shopping offers many benefits including: allowing customers to shop from literally anywhere in the world; eliminating the costs associated with having to ship, store, and sell items from traditional retail store locations; and enabling manufacturers and distributors to reach a larger market.

However, despite these advantages, remote shopping is not without its drawbacks. Most prominent among such drawbacks is the lag time between purchasing an item and having it delivered. With the exception of digital goods that can be downloaded over the internet, most goods purchased by remote shopping need to be delivered to the purchaser's home or business. This can take days, if not weeks, and is subject to the intrinsic costs, hazards, unpredictability and obstacles of traditional parcel/package delivery and current logistics and transportation models.

Companies are attempting to minimize the delay between purchase and delivery and maximize customer satisfaction by offering same day delivery in certain cities. However, this can be very costly and inefficient as it requires a large number of vehicles and employees to be in reserve or on call to deliver items individually as they are purchased. This increases the delivery cost, and also increases traffic congestion and carbon emissions.

One suggestion to improve delivery services that does not have the drawbacks of conventional same day delivery is the use of unmanned aerial vehicles/drones. Low flying drones, such as quadcopters and octocopters, can be used to carry and deliver parcels directly to customers' locations, using global positioning system technology, machine vision, artificial intelligence, autonomous navigation, telemetry, metadata and/or commands from a remote operator. These drones promise to be more cost effective than human delivery and faster as they can bypass traffic and are not limited to following paved roads.

As consumer demand for same day delivery rises, drones are rapidly becoming a viable technology for many delivery services and companies.

As part of drone delivery systems, several companies have begun producing parcel-receiving devices, such as landing pads/landing stations to meet the coming demand for secure locations for drone delivery.

These landing stations can be improved by creating landing stations configured to be quickly and/or removably deployed to different locations, receive different sized packages from different types of drones, and keep the packages (and drones) safe, secure in weatherproof and/or climate-controlled vaults.

### SUMMARY OF THE INVENTION

In some embodiments, a landing station can include: a landing surface; a package manipulation system; an elevator; a first anchor; a second anchor; a third anchor; a fourth anchor; a lifting ring; and/or a climate control system.

In some embodiments, the package manipulation system includes at least one manipulation rail. In some embodiments, the package manipulation system includes a pair of manipulation rails. In some embodiments, the package manipulation system includes a set of projections configured to raise and lower packages from the landing surface. In some embodiments, the package manipulation system includes at least one finger. In some embodiments, the package manipulation system includes a pair of fingers.

In some embodiments, the first anchor is retractable. In some embodiments, the first anchor is raised and lowered by a first linear actuator. In some embodiments, the second anchor is raised and lowered by a second linear actuator.

In some embodiments, a landing station can include a first locker kept at a first temperature; and a second locker kept at a second temperature. In some embodiments, a landing station can include an air curtain blower.

In some embodiments, the first locker contains an overhead heater and a sensor.

In some embodiments, a landing station can include a temperature control carrier.

In some embodiments, a landing station can include a convertible storage locker. In some embodiments, the convertible storage locker is made up of four single locker compartments that can be converted into two double wide lockers, two double high, or a single quad-sized locker.

In some embodiments, a landing station can include a movable internal partition that separates two of four single locker compartments from each other, wherein the movable internal partition is motorized.

In some embodiments, a landing station can include hinged locker doors that can open or close based on the required dimensions of the convertible storage locker.

In some embodiments, a landing station can include four hinged locker doors configured to open based on the arrangement of the convertible storage locker.

In some embodiments, a landing station can include a set of partition manipulation actuators and/or a dovetail partition.

Methods for deploying a landing station are also disclosed.

### BRIEF DESCRIPTION OF THE DRAWINGS

FIG. 1 is a partial cross-sectional perspective view of a package manipulation system for a drone landing station supporting a package.

FIG. 2 is a side view of an embodiment of a package manipulation system for a drone landing station, showing how the package is supported and gripped.

FIG. 3 is a side view of an embodiment of a package manipulation station showing a package lowered onto an elevator.

FIG. 4 is a perspective view of a drone landing station with an apparatus to anchor the drone landing station to the ground.

FIG. 5 illustrates a method of placing a landing station using an installation vehicle.

FIG. 6 is a cross-sectional side view of a drone landing station, showing an anchor in a retracted position and an anchor in an extended position.

FIG. 7 is a cross-sectional perspective view of an embodiment of a landing station with an apparatus to manage temperatures of the interior of the landing station.

FIG. 8 is a cross-sectional perspective view of an embodiment of a landing station providing individual temperature control for various package lockers.

FIG. 9 is a cross-sectional perspective view of an apparatus maintaining the internal temperature of a package during shipment and storage using a temperature-controlled sleeve that travels with the package and is stored in a package locker.

FIG. 10 is a cross-sectional perspective view of an embodiment of a landing station with individually temperature controlled lockers using heating and cooling ducts with controllable valves.

FIG. 11 is a perspective front view of a landing station with convertible package lockers.

FIG. 12 is a cross-sectional perspective rear view of an internal arrangement of convertible package lockers.

FIG. 13 is a cross-sectional perspective rear view of another embodiment of convertible package lockers.

### DETAILED DESCRIPTION OF THE ILLUSTRATIVE EMBODIMENTS

### Package Manipulation Systems

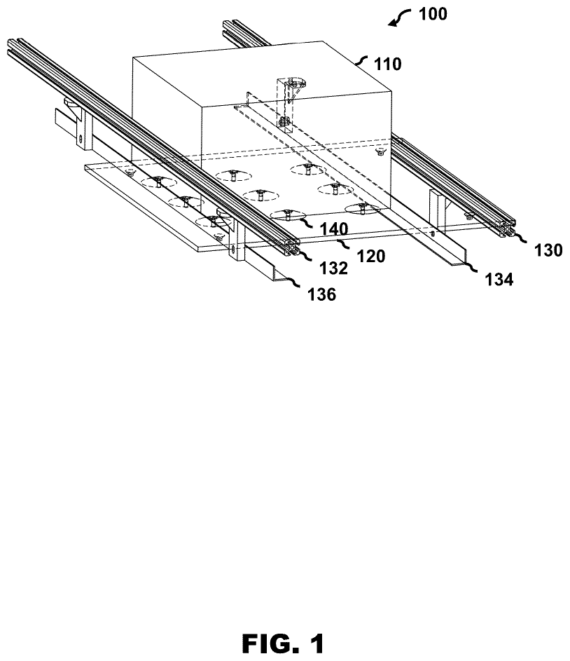

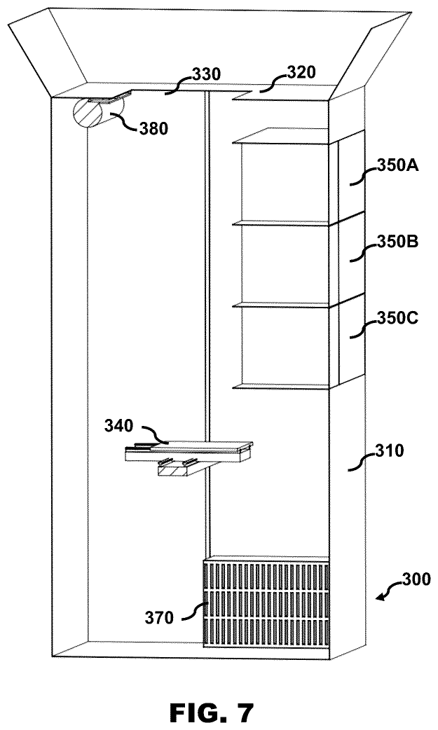

FIG. 1 is a perspective view of an embodiment of a package manipulation system for drone landing station 100. In some drone landing stations, such as the one depicted in FIG. 7, an aerial vehicle deposits a package on the top of a robotic system that is configured to accept different sizes and weights of packages, and draw them inside the landing station to be secured and protected. In at least some embodiments, the landing station includes a large, planar landing surface that is often the highest surface to avoid interfering with drones' undercarriages as they take off and land. In at least some embodiments, the landing surface has a top hatch that opens to allow packages to pass through the landing surface and into the robotic package handling equipment below. In some embodiments, the top hatch is in the approximate center of the landing surface. The challenge is that this hatch must be opened, and a robotic elevator platform must pass up through it while the drone and/or package is supported from above. If this support is not reliable, packages and/or parts of the drone, can uncontrollably fall through the hatch into the interior of the landing station, jamming up the robotics, and possibly damaging the drone, internal mechanism of the landing station and/or contents of the package.

In some embodiments, package manipulation systems support a package during the robotic operations of opening the top hatch and raising the package elevator in a landing station.

In some embodiments, a package manipulation system can reliably grasp, align, manipulate, and/or store packages and drones of various sizes.

In some embodiments, a package manipulation system has two primary physical components. The first is a set of shallow truncated conical projections 140 on top of the top door hatch to slightly elevate package 110 from landing surface 120. The second is a set of fingers (134 and 136) that slide under the edges of package 110, holding it up as the top door hatch opens. Fingers (134 and 136) can be associated with a package centering mechanism such as those disclosed in International Publication PCT/US2021/036237 which is also incorporated herein its entirety.

In operation, a drone deposits package 110 on landing surface 120. The centering mechanism pushes package 110 towards the center, and onto the top door hatch. In some embodiments, centering mechanism utilizes package manipulation rails 130, 132 to close in upon package 110 and drive it to the center of landing surface 120. In some embodiments, package manipulation rails 130, 132 are driven by robotic actuators (not shown). In some embodiments, a second, orthogonal pair of package manipulation rails center the package in the orthogonal direction (not shown).

Projections 140 slightly elevate package 110, allowing fingers (134 and 136) on the centering mechanism to project under package 110. In some embodiments, projections 140 are conical. In some embodiments, projections 140 are shallow, truncated cones. In some embodiments, projections 140 are truncated spheres.

In some embodiments, as package manipulation rails 130, 132 move package 110 about landing surface 120, the sides of projections 140 act as ramps, guiding package 110 up onto truncated tops of projections 140.

Once package 110 is on top of projections 140, there is a gap between the bottom of package 110 and the top of landing surface 120. Fingers 134, 136 are able to enter this gap, thereby supporting package 110 from below.

At this stage, package manipulation rails 130 and 132 are driven inwards, “squeezing” package 110 between, and securely holding it on two sides. At this point, package 110 is secured in three dimensions, and aligned with the center of landing surface 120.

The centering mechanism continues to close until it has securely grasped package 110. At this point, package 110 is supported from below by fingers (134 and 136), and the top door hatch can be opened.

Next, a portion of landing surface 120 that constitutes the top hatch of the landing station drops out from below. In some embodiments, this is done via a robotic actuator. Package 110 is securely supported from the side by package manipulation rails 130,132, and from below by fingers 134, 136. The robotic equipment inside the landing station moves the portion of landing surface 120 containing conical projections 140 out of the way, and replaces it with an elevator platform 150 which raises up to a level approximately equal to the bottoms of fingers 134, 136. At this point, package manipulation rails 130, 132 and fingers 134, 136 are driven away from center, releasing package 110 onto the elevator, enabling it to be reliably drawn inside the landing station.

In some embodiments, the elevator ascends through the top hatch opening to contact the bottom of package 110, the centering mechanism retracts the fingers to beyond the extent of the hatch opening, gently dropping package 110 a short distance onto the elevator, and the elevator can be lowered into the interior of the landing station carrying package 110. In other embodiments, the elevator ascends further to lift the package slightly off fingers (134 and 136) prior to them retracting. In some embodiments, it can be necessary to coordinate a loosening of rails (130 and 132) with the upward motion of the elevator to balance the forces on package 110.

In some embodiments, fingers (134 and 136) can include interdigitated forks that slide between projections 140, enabling the manipulation of a greater range of package sizes.

In some embodiments, fingers (134 and 136) can be used to engage slots or other features in the drone to help stabilize a drone in high winds and/or to help prevent its removal from the top of the landing station by unauthorized agents.

In some embodiments, rails (130, 132) and/or fingers (134 and 136) can include electrical contacts to enable charging of the drone's batteries.

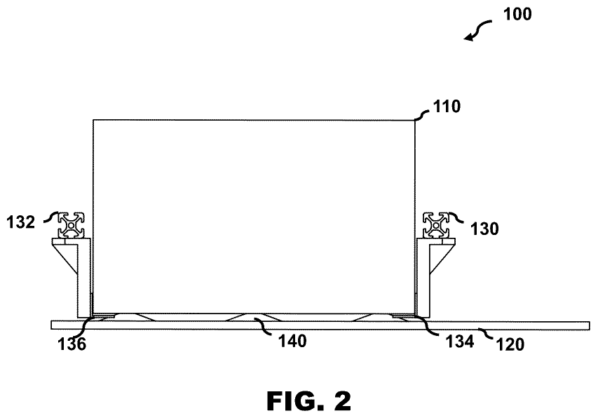

FIG. 2 is a front view of package manipulation system for drone landing station 100. Package 110 is dropped on landing surface 120. Package manipulation rails 130, 132 are moved to push package 110 to the center of landing surface 120. As package moves over projections 140, it is raised a small distance off of landing surface 120, creating clearance for fingers 134, 136 to pass below it. At this point, package manipulation rails 130, 132 are driven inwards to secure package 110 laterally, and force fingers 134, 136 fully underneath it.

In some embodiments, at this point the center section of landing surface 120 containing projections 140 drops away, and package 110 is secured and supported as an elevator platform raises up, and package manipulation rails 130, 132 and fingers 134, 136 move out of the way to gently deposit package 110 on the elevator platform to be moved inside the landing station.

In some embodiments, projections 140 are conical.

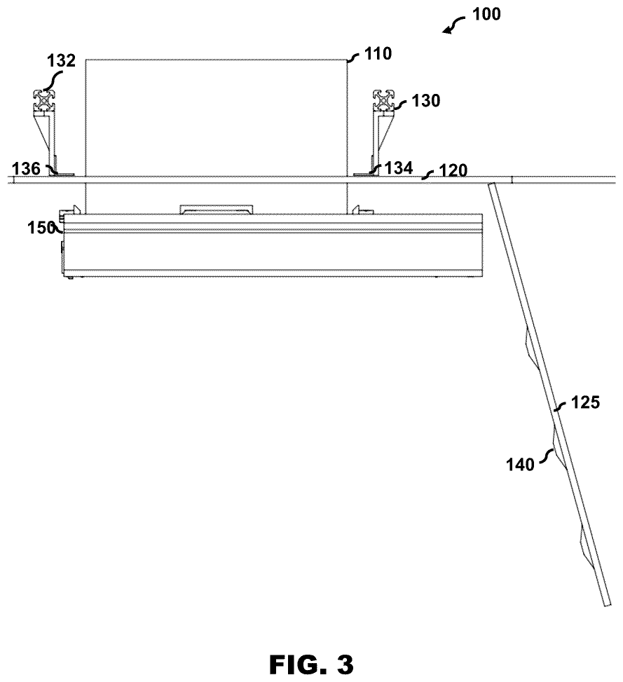

FIG. 3 illustrates the condition of landing station 100 immediately after package 110 is deposited onto elevator 150. In some embodiments, a sequence of events starts with the package being fully secured by package manipulation rails 130 and 132, and fingers 134 and 136, as shown on FIG. 2. In some embodiments, at this point, top hatch 125 with attached projections 140 pivots into the inner volume of landing station 100. Then package elevator 150 enters up through the opening in landing surface 120 created by the motion of top hatch 125, and contacts the bottom of package 110. In some embodiments, package manipulation rails 130 and 132 are then driven away from package 110, carrying fingers 134, and 136 along with them until they clear the bottom of the package, gently dropping it onto waiting elevator 150. In some embodiments, at this point, elevator 150 can descend into the interior of landing station 100, and then move the package into a designated storage locker. In some embodiment, the final operation is to move top hatch 125 back to its horizontal position, thereby securing and weatherproofing the interior of landing station 100.

### Landing Stations with Anchors and Methods of Employing Them

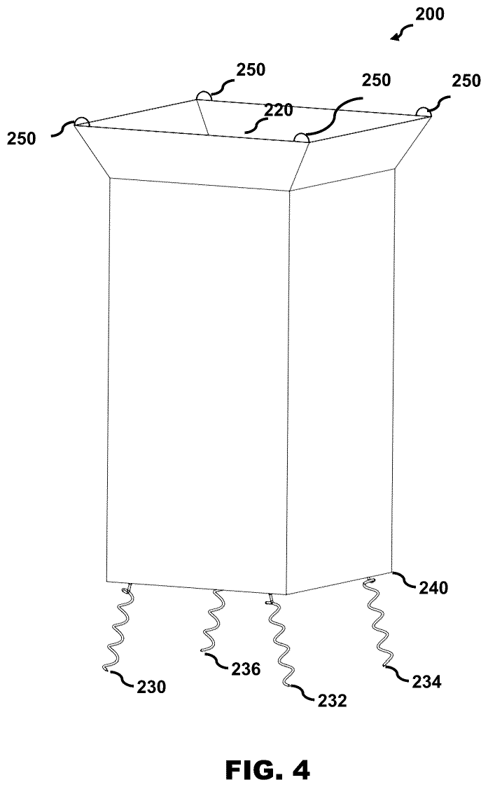

FIG. 4 is a perspective view of drone landing station 200 configured to be anchored into the ground using retractable anchors 230, 232, 234 and 236. In some embodiments, retractable anchors 230, 232, 234 and 236 are soil anchors. Drone landing station 200 comprises drone landing surface 220 and a number of internal robotic elements to manipulate and securely store packages inside.

In some embodiments, drone landing station 200 is installed in a temporary location and/or on an earthen foundation. Landing stations, by virtue of their large landing surface located high off the ground can be top-heavy and require stable foundations and ground attachments to prevent tipping hazards such as from high winds. Landing stations can also require positive attachment to the ground to prevent their unauthorized moving or removal.

In some embodiments, an automatically deployable anchor system comprising retractable anchors 230, 232, 234 and 236 secures landing station 200 to the ground. Using this system, landing station 200 can be delivered and securely installed to a remote or temporary locations via truck and crane, autonomous land vehicles, and/or heavy-lift aerial vehicles to facilitate rapid deployment without the need for traditional foundations. In some embodiments, the vehicles can temporarily secure landing station 200 via lifting rings 250. In some embodiments, this aids in the deployment of landing station 200 in undeveloped areas. In some embodiments, this aids in the temporary deployment of landing station 200 where it is only to be used at a given location for a short time (for example during a special event or as part of an emergency response). In some of these temporary deployments, the expense and time of creating a foundation and/or the disruption of drilling holes in existing pavement is not desired.

In some embodiments this allows for landing station 200 to be deployed in situations where a concrete (or similar structural material) mounting pad is either unavailable and/or not possible.

In some embodiments, anchors 230, 232, 234 and 236 are helical anchors or augers that extend from bottom surface 240 of landing station 200, and “screw into” the soil. Once fully deployed, the arrangement of anchors provides a rigid foundation for the landing station, preventing tipping and its unauthorized removal. In some embodiments, anchors 230, 232, 234 and 236 are driven into the soil by high-torque rotary actuators to turn anchors 230, 232, 234 and 236 and linear actuators to control their depth into the soil. In some embodiments, such as the one shown in FIG. 4, landing station 200 uses a set of four independently-controlled anchors splayed out at an angle from the four bottom corners of landing station 200. In some embodiments, the angle from vertical of the anchors improves the landing station's resistance to various forces that can upend or attempt to remove it. In some embodiments, once all four anchors are fully screwed into the soil by the rotary actuators, the linear actuators can independently raise or lower the corners of landing station 200, leveling it.

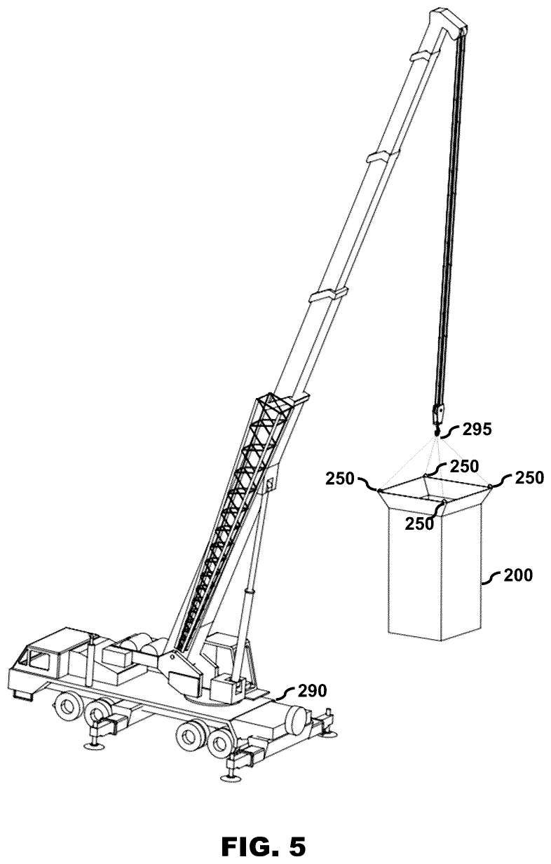

FIG. 5 is an example method for installation of landing station 200. In some embodiments, installation vehicle 290 can be a mobile crane, as shown, heavy lift aerial vehicle, or crane-equipped seagoing barge. In some embodiments, a set of rigging 295 or cargo management actuators on installation vehicle 290 connects to lifting rings 250 on landing station 200. In some embodiments, installation vehicle 290 moves landing station 200 from a base of operations to its intended installation location and lowers it to ground level. In some embodiments, while landing station 200 is still connected via rigging 295, soil anchors 230, 232, 234 and 236 (FIG. 4) are driven into the ground. In some embodiments, once landing station 200 is secured to the ground, rigging 295 releases from lifting rings 250, and the installation vehicle can return to base. In some embodiments, once landing station 200 has completed its deployment at the installation location, installation vehicle 290 can return, reattach rigging 295 to lifting rings 250, command soil anchors 230, 232, 234 and 236 to retract from the ground, and landing station 200 can be lifted and moved back to base by installation vehicle 290. In some embodiments, the connections between rigging 295 and lifting rings 250 are made and unmade by robotic actuators, eliminating the necessity of sending humans to manage the loading or unloading of landing stations 200. Said robotic actuators can be parts of lifting rings 250 or rigging 295.

Once a landing station 200 has finished its assignment at a given location, the above procedure can be reversed. Lifting vehicle is dispatched to the landing station's location. Lifting devices (such as cables or robotic clamps) are aligned and attached to lifting rings 250, securing landing station 200 to the lifting vehicle. Then, anchors 230, 232, 234, 236 are driven in the opposite direction to free them from the soil and retract them fully (or at least partially) into the body of landing station 200. At this point, landing station 200 is free, and lifting vehicle can raise it from ground level, and transport it back to the staging area or warehouse for refurbishment and reuse.

In some embodiments, landing station 200 is deployed at a location, secured using a retractable anchor system, and then removed after a given time. Methods of deploying and retrieving landing station(s) 200 are disclosed below. In some embodiments, when landing station 200 is to be delivered to a remote or temporary location, a lifting vehicle can be dispatched to a staging area, warehouse, or other location where landing station 200 is stored. In some embodiments, the lifting vehicle attaches to landing station 200 via lifting rings 250. In some embodiments, landing station 200 is lifted into a transport vehicle, and secured for its journey to its deployment position. Lifting vehicle could be a land vehicle, such as a truck equipped with a crane, a nautical vessel, also equipped with a crane, or a heavy lift aerial vehicle such as a large drone or rotorcraft. Landing station 200 is transported to its deployment location. Once landing station 200 arrives, the lifting vehicle completes a precision drop of landing station 200 onto soil, turf, gravel or some another soft surface. In some embodiments, lifting vehicle maintains connection to lifting rings 250 to stabilize landing station 200 during deployment. At this point anchors 230, 232, 234, 236 are in their retracted position fully (or at least partially) inside of the body of landing station 200. In some embodiments, cybersecurity software controls the permissions to operate anchors 230, 232, 234, 236, lifting rings 250 and rigging 295, preventing unauthorized installation or removal of landing station 200.

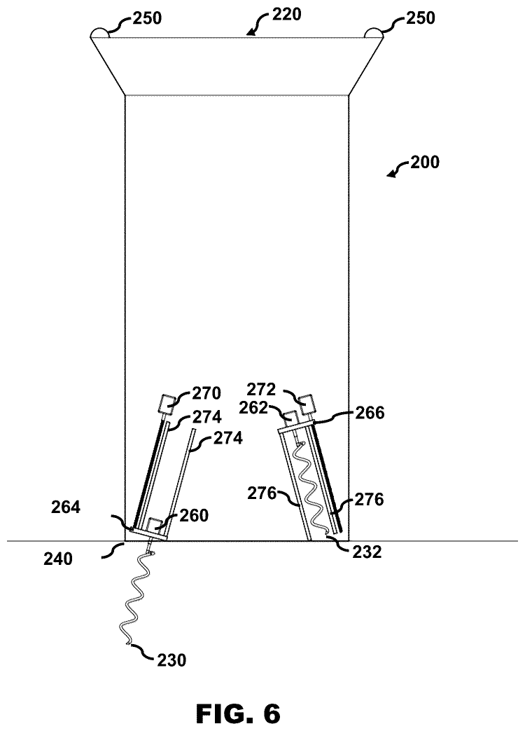

FIG. 6 is a front cross-sectional view landing station, 200. In some embodiments, landing station 200 includes landing surface 220 and lifting rings 250. The bottom 240 of landing station is at ground level in FIG. 6.

In some embodiments, plurality of anchors 230, 232 serve to anchor landing station 200 to the ground. For illustrative purposes, two anchors are shown, anchor 230 in a fully extended position and anchor 232 in a fully retracted position. Various embodiments of landing station 200 can include various number of anchors. In some embodiments, landing station 200 has one anchor. In some embodiments, landing station 200 has two, three, four, five, or six anchors.

In some embodiments, at least one anchor assembly includes a drive mechanism that can independently twist anchor 230 and move it in and out of the ground. In some embodiments, the anchors (such as anchor 230, 232) are driven by high-torque rotary actuators 260, 262 capable of twisting their corkscrew or auger structures into various soil conditions. In some embodiments, rotary actuators 260, 262 are attached to movable carriages 264, 266. In some embodiments, movable carriages 264, 266 are guided by sets of rails 274, 276 that define their linear path of motion and attach the anchor assemblies to the structure of landing station 200. In some embodiments, linear actuators 270, 272 drive carriages 264, 266 along rails 274, 276 to advance or withdraw anchors 230, 232 into or out of the ground.

In some embodiments, in operation, anchor 230, 232 are initially withdrawn completely (or at least partially) into the body of landing station 200, as illustrated by the position of anchor 232. Upon command, rotary actuator 262 begins to turn anchor 232 in the direction to cause it to screw into the ground. In some embodiments, linear actuator 272 causes anchor 232 to advance its position until it bites into the soil. At this point, at least in some embodiments, sensors monitor the positions, forces, torques and/or motor speeds of the assembly and coordinate the rotation of rotary actuator 262 with the position of linear actuator 272 to aid in smooth operation as anchor 232 is driven into the ground.

In some embodiments, such as those with favorable soil conditions, the anchors can be fully extended, as indicated by the position of anchor 230. In some embodiments, if an anchor hits an underground obstruction, it can stall when partially extended. In some embodiments, the system can look at the sensor readings and determine if the anchor will likely provide enough anchor force. In some embodiments, the delivery vehicle has the option to command the anchors retract, and landing station 200 can be moved a short distance to find more favorable soil conditions, and reengage the anchors.

In some embodiments, once anchors 230, 232 are extended to the desired distance underground, rotary actuators 260, 262 are locked in place, preventing further rotation of anchors 230, 232. In some embodiments, at this point linear actuators 270, 272 can drive carriages 264, 266 incrementally up or down until inertial sensors determine that landing station 200 is level. In some embodiments, once landing station 200 is level, linear actuators 270, 272 are locked, preventing further movement of carriages 264, 266, providing a firm, stable, level foundation. In some embodiments, linear actuators 270, 272 can be reengaged, either automatically or manually, if the system determines that landing station 200 is no longer level, for example if the ground shifts.

In some embodiments, linear actuators 270 and 272 are replaced with or supplemented by an actuator that causes rails 274, 276 to pivot and/or fold. Upon command, actuators associated with anchors 230, 232, 234, 236 begin to rotate and drive them into the ground, penetrating below the soil level. In at least some embodiments, anchors 230, 232, 234, 236 are splayed out at an angle providing a firmer footing for landing station 200, and better resisting forces that would topple or lift landing station 200 from its deployment location without authorization. In some embodiments, the splay angle is between, and inclusive of, 45 degrees to 90 degrees from horizontal. In some embodiments, the splay angle is between, and inclusive of, 35 degrees to 85 degrees. Once anchors 230, 232, 234, 236 are fully seated in the soil, the lifting vehicle can disengage from lifting rings 250, and landing station 200 is secured in place. The lifting vehicle can then return to the staging area or warehouse to start its next installation.

In at least some embodiments, anchors 230, 232, 234, 236 can be individually driven up or down, independently leveling the four corners of landing station 200.

### Landing Stations with Climate Control Features

In some embodiments, packages stored within a landing station must be maintained within specific temperature ranges. In some embodiments, a landing station has thermal control capabilities to manage the overall internal temperature of the landing station. In some embodiments, the landing station provides individual control over the temperature of specific zones, lockers or packages. In some embodiments, temperature control can involve the maintenance of refrigerated and/or frozen temperatures and/or maintaining the package at a specified temperature hotter than ambient. In some embodiments, sensors and thermal isolators are employed to maintain temperature control over specific regions of the landing station and/or the packages stored in it.

In some embodiments, centralized heating and/or cooling systems condition the entire internal volume of a landing station to the same temperature. This can protect packages from freezing during cold weather, keep perishable cargo cool, or maintain hot food deliveries at temperature levels as required by food safety concerns, and also keep landing station equipment and fittings within their normal operating ranges of temperature. In some embodiments, it is desirable to protect some packages from excessive temperatures such as those caused by solar loads on the cabinet of a landing station or the power dissipation of its internal components. In some embodiments multiple landing stations can be made available, each kept at different internal temperatures, allowing dispatching systems to select the landing station with an internal temperature closest to the target temperature for each package.

FIG. 7 is a cross-sectional view of landing station 300 configured to maintain packages stored in it a particular temperature or temperature range.

In some embodiments, landing station outer cabinet 310 is subject to outdoor environmental conditions such as solar load, wind, and/or external air temperatures. In some embodiments, it is important to maintain the temperature inside landing station 300 within prescribed limits to ensure internal components do not malfunction and/or that the packages stored inside are not harmed. In some embodiments, landing surface 320 accepts drones carrying packages, and aperture 330 allows robotic package handling equipment 340 to move packages between the drone and a number of internal package lockers 350A, 350B and 350C. In some embodiments, the temperatures internal lockers are maintained to protect the contents of the stored packages.

In some embodiments, the internal volume of landing station 300 is conditioned with temperature control unit 370. In some embodiments, temperature control unit 370 can optionally heat and/or cool the internal volume of landing station 300. In some embodiments, temperature control unit 370 is a resistive heater that is capable of compensating for heat loss through landing station outer cabinet 310 and/or aperture 330 to cooler ambient air. In some embodiments, temperature control unit 370 has electrically heated elements controlled by a thermostat and/or a circulating fan to move heated air throughout the inner volume of landing station 300. In at least some embodiments, landing station 300 can protect packages stored within the volume of landing station 300 from excessive cold or freezing. In some embodiments, temperature control unit 370 also controls the humidity in the interior of landing station 300.

In some embodiments, temperature control unit 370 is an air conditioner, include refrigerant, a compressor, expansion valve and heat exchangers. In some embodiments, the temperature control unit 370 can compensate for heat caused by solar load on cabinet 310 and/or the power dissipation of internal components of the landing station such as robotic package handling equipment 340. In at least some embodiments, landing station 300 can protect packages stored within the volume of landing station 300 from being damaged by excessive heat.

In some embodiments, temperature control unit 370 is a heat pump or Peltier device capable of performing either heating or cooling functions.

In some embodiments, temperature control unit 370 is connected to an external source of heat transfer fluid at a moderate temperature, such as a ground coupled heat exchanger or connected to a steam/heated/chilled water plant in a nearby building. In some embodiments, temperature control unit 370 uses ambient air surrounding landing station 300 as a source or sink of heat as it maintains the temperature inside of cabinet 310.

In at least some embodiments, heated/conditioned air from the interior of landing station 300 can be lost to the outside environment through package loading aperture 330. In some embodiments, this effect can be minimized through the use of air curtain blower 380. In some embodiments, air curtain blower 380 takes conditioned air from the interior of landing station 300 and uses a fan to accelerate it as a sheet of high velocity air across the bottom of aperture 330 creating a barrier, thereby reducing the flow of conditioned air between the interior of landing station 300 and the outside environment. In some embodiments, as robotic equipment 340 raises and lowers packages through aperture 330, the air curtain produced by blower 380 wraps around robotic equipment 340 and any packages it is carrying, and helps to preserve conditioned air within landing station 300. In some embodiments, the functions of temperature control unit 370 are integrated into air curtain blower 380.

In some embodiments (such as the one shown in FIG. 7) all packages stored in package lockers 350A, 350B and 350C are maintained at substantially the same temperature, as regulated by common temperature control unit 370.

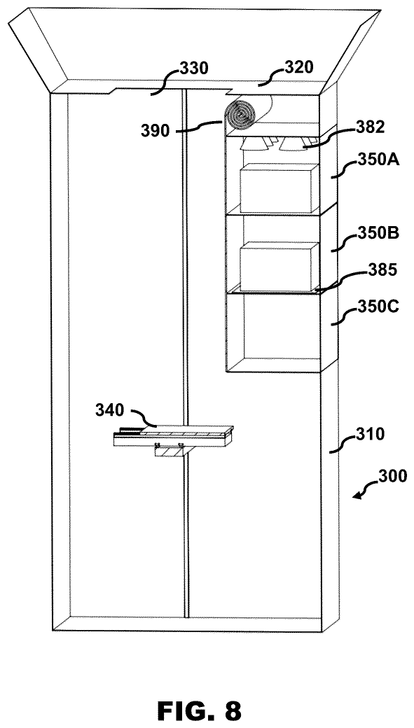

FIG. 8 is another embodiment of thermal control for landing station 300. In some embodiments (such as the one shown in FIG. 8) individual package lockers have independent control of heaters to maintain prescribed temperatures for each package. In some embodiments, such as FIG. 8, landing station 300 is concerned only with heating the contents of the lockers, and not cooling. In some embodiments, landing station 300 has outer cabinet 310, landing surface 320 package aperture 330, and/or robotic package handling equipment 340. In FIG. 8, three package lockers are shown, 350A, 350B and 350C.

In some embodiments, package lockers, such as package locker 350A in FIG. 8 are equipped with one or more overhead heaters 382 such as heat lamps or a resistive heating elements. In some embodiments, a sensor detects the temperature of package locker 350A and through computer control and power electronics, operates overhead heaters 382 in order to maintain the prescribed temperature inside package locker 350A.

In some embodiments, package lockers, such as package locker 350B in FIG. 8 is equipped with heating pad 385. In some embodiments, heating pad 385 substantially covers the floor of package locker 350B. In some embodiments, a sensor detects the temperature of package locker 350B, and through computer control and power electronics, operates heating pad 385 in order to maintain the prescribed temperature inside package locker 350B.

In some embodiments, such as the one shown in FIG. 8, roll-up door 390 seals the rear opening of package lockers 350A, 350B and/or 350C. In some embodiments, roll-up door 390 can be controlled to temporarily uncover the rear opening of package lockers 350A, 350B, and/or 350C so robotic package handling equipment 340 can access them to insert or withdraw packages from behind. In some embodiments, during the majority of times when the robotic package handling equipment is not operating, roll-up door 390 is fully extended, sealing the back and thereby confining the desired air temperature inside package lockers 350A, 350B and/or 350C. In some embodiments, roll-up door 390 is driven by a motorized drum and track arrangement. In some embodiments, the free end of roll-up door 390 is attached via a linkage to the robotic package handling equipment 340, so when it is moved to the appropriate position, roll-up door 390 rolls to its fully closed position, sealing package lockers 350A, 350B and/or 350C.

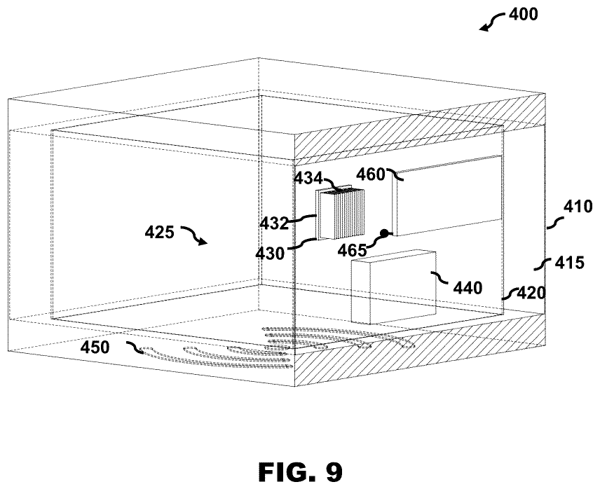

In some embodiments, such as the one shown in FIG. 9, temperature control carrier 400 is utilized that contains the cargo to be delivered in its interior. In some embodiments, temperature control carrier 400 can be transferred from an originating place, carried by a drone, and deposited in a receiving landing station (such as landing station 300 in FIG. 7) all while maintaining the required temperature for the cargo inside.

In some embodiments, temperature control carrier 400 has outer case 410, inner case 420, and thermal insulation 415 between outer case 410 and inner case 420. In some embodiments, interior volume 425 of temperature control carrier 400 contains the temperature sensitive cargo.

In some embodiments, thermal control element 430 moves heat between internal volume 425 and the outside environment to cool the contents or between the external environment and internal volume 425 to heat the contents. In some embodiments, thermal control element 430 is a thermoelectric module such as a Peltier device with a heat transfer surface 432 coupled to inner case 420 to control the temperature of the internal volume 425 and a heat sink 434 in the ambient air, which can move heat in either direction depending upon the polarity of the electric current applied to thermal control element 430. Thus, in such embodiments, a single temperature control carrier 400 can be used for cargo that must be heated above ambient temperature or cooled below ambient temperature. In some embodiments, thermal control element 430 could be a combination of a resistive heater, a compressor-driven refrigeration unit and/or a heat pump.

In some embodiments, energy to operate thermal control element 430 can come from two sources. In some embodiments, when temperature control carrier 400 is located within a landing station (for example, stored in package locker 350C on FIG. 7) wireless power receiving device 450 couples energy from the landing station to thermal control element 430. In some embodiments, power receiving device 450 is a set of electrical contacts or an inductive or magnetic wireless charging system. In some embodiments, heating pad 385 (FIG. 8) is replaced with a power transmitting device that couples with power receiving device 450 to facilitate the transfer of energy from landing station 300 into any temperature-controlled carriers 400 stored within it. In some embodiments, when the temperature control carrier 400 is not located in a package locker with power receiving device 450 (for example, while flying on a drone or being manipulated by package handling robotics 340 on FIG. 8, battery 440 within temperature control carrier 400 supplies the energy needed to operate thermal control element 430. In some embodiments, control/interface module 460 manages the setpoint for the target temperature of internal volume 425 based upon feedback from internal temperature sensor 465. In some embodiments, control/interface module 460 has a user interface allowing individuals to control and/or monitor temperatures and battery energy. In some embodiments, control/interface module 460 has a communications interface enabling temperature control carrier 400 to interact with the landing station, drone, and/or ground based computer networks to receive instructions on the desired temperature set point of cargo volume 425, and report status.

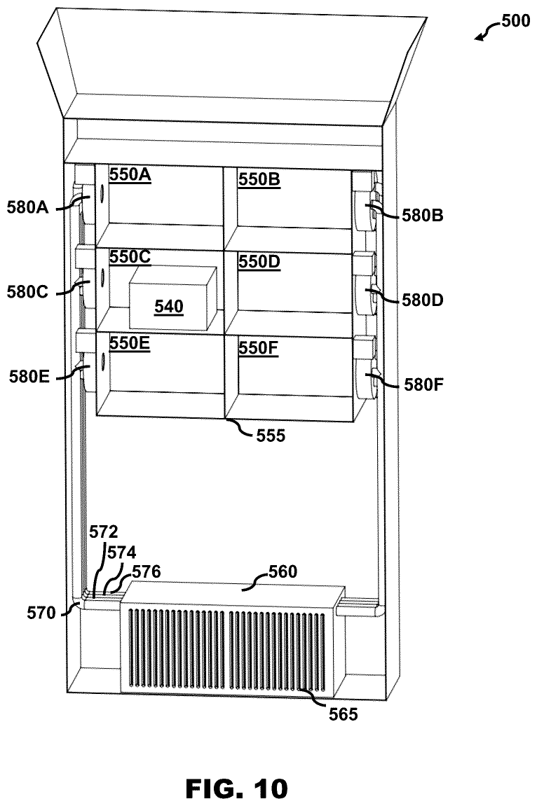

FIG. 10 is a cross-sectional view of an embodiment of temperature-controlled landing station 500 that uses a central environmental control unit to supply conditioned air to individual package lockers through a network of ducts and valves. Package 540 resides in one of a number of package storage lockers 550A, 550B, 550C, 550D, 550E, and 550F. In some embodiments, the walls separating and surrounding package storage lockers 555 include thermal insulation, preventing, or at least reducing, undesired heat flow. In some embodiments the rear of package storage lockers 550A, 550B, 550C, 550D, 550E, and 550F are isolated from the interior volume of landing station 500 via a roll-up door similar to roll-up door 390 in FIG. 8.

In some embodiments, central environmental control unit 560 is capable of making one or more pressurized air streams controlled to specific temperatures. In some embodiments, distinct pressurized air streams are produced by central environmental control unit 560. In some preferred embodiments, distinct pressurized air streams are produced by central environmental control unit 560 and can include frozen (at approximately −20° C.), refrigerated (at approximately +5° C.), room temperature (at approximately +25° C.), and/or heated (at approximately +70° C.). In some preferred embodiments, distinct pressurized air streams of adjustable temperatures are produced by central environmental control unit 560 and can include frozen range (at approximately: −40° C. to 0° C.), refrigerated range (at approximately 0° C. to 15° C.), room temperature range (at approximately 15° C. to 40° C.), and/or heated range (at approximately 40° C. to 80° C.).

In some embodiments, environmental control unit 560 is a heat pump that uses a single compressor system or Peltier module array to create the pressurized air outputs. In some embodiments, ambient air duct 565 admits air from outside landing station 500 to provide additional heat or cooling as needed by environmental control unit 560. In some embodiments, fans, blowers and/or dampers within central environmental control unit 560 maintain appropriate air flow pressures and volumes throughout the system, and sensors monitor the air stream characteristics and control their set points. In some embodiments, the environmental control unit saves energy by pumping heat from the refrigerated or frozen air streams to the heated air stream. In some embodiments, central environmental control unit 560 also controls the humidity of the air streams it produces.

In some embodiments, such as the one shown in FIG. 10, four sets of air ducts distribute various pressurized air streams from centralized environmental control unit 560 to package storage lockers 550A, 550B, 550C, 550D, 550E, and 550F. In some embodiments, these are frozen air duct 570, refrigerated air duct 572, room temperature air duct 574 and heated air duct 576. In some embodiments, these ducts circulate the pressurized air streams created by centralized environmental control unit 560 throughout landing station 500. In some embodiments, additional ducts (not shown) carry one or more of the four conditioned air streams to the top of the unit, conditioning the volume where a drone can be stored, maintaining the drone's operating temperature and/or humidity range, and/or controlling the buildup of ice, snow, or condensation on the landing apparatus, and throughout the landing station. In some embodiments, specialized ducting arrangements can isolate airflows to different parts of the drone, and condition them to desired temperatures (for example cooling the drone's batteries as they charge, while maintaining rotor motors at a different operating temperature).

In some embodiments, each package locker 550A, 550B, 550C, 550D, 550E, and 550F has its own air control valve 580A, 580B, 580C, 580D, 580E, and 580F. In some embodiments, these valves are five port devices, accepting connections from pressurized air ducts 570, 572, 574 and 576, and creating the output air temperature required by the package stored in that specific locker. In some embodiments, valves 580A, 580B, 580C, 580D, 580E, and 580F have four input ports arranged around a circular valve body, and a servo motor capable of turning an internal vane in the orientation needed to connect the output port to the selected input duct, under computer or thermostatic control.

In some embodiments, the motor/vane combination is capable of stopping partially between two input ducts, permitting the creation of different input air temperatures. For example, in FIG. 10, by equally mixing +5° C. refrigerated air and +25° C. room temperature air, via valve 580C, package 540 stored in package locker 550C could be maintained at +15° C.

In some embodiments, the motor/vane combination is capable in stopping in a closed position, where no air ducts are connected to package lockers. In some embodiments, this saves energy on empty lockers, lockers containing packages without critical temperature requirements, and/or lockers where the desired temperature has already been achieved. In some embodiments, sensors in the lockers are used by control systems to monitor the temperature inside, and set the position of the servo motors and vanes to admit the correct quantity of the pressurized air from the selected duct(s).

In some embodiments, additional valve ports and air ducts return air from package lockers 550A, 550B, 550C, 550D, 550E, and 550F back to centralized environmental control unit 560, enabling continuous circulation of appropriately conditioned air to each package locker, and saving energy. In some embodiments, each package locker 550A, 550B, 550C, 550D, 550E, and 550F includes an exhaust port that allows some of the conditioned air from the locker to enter the inner case of landing station 500, and from there be recirculated into centralized environmental control unit 560, thus maintaining continuous air movement throughout the system.

In some embodiments for temperature-controlled package lockers, the dispatch software that coordinates orders, drones and landing stations informs the receiving landing stations of the thermal requirements of packages expected to be delivered to them. The landing station pre-conditions the interior of the locker designated for storing that package to the correct temperature, so when the drone delivers it, the correct storage locker temperature has, or is being, established.

### Landing Stations with Convertible Lockers

In some embodiments, a landing station can include convertible lockers with movable partitions between adjacent lockers that allow the landing station to combine two or more smaller lockers into one or more larger ones.

In some embodiments, a landing station has four single sized lockers (arrange two by two) with pairs of lockers stacked on top of each other. In some embodiments, the four partitions that separate them could be reconfigured, removed, and/or replaced as needed. In some embodiments, this allows for the creation of two double wide lockers, two double high lockers, a single quad-sized lockers, or a combination of a double wide or double high locker with two single sized lockers.

In some embodiments, the four movable internal partitions that separate a cluster of four package lockers can be driven by motorized actuators to either extend the partition into the volume of the cluster of lockers to separate one locker from the others, or retracted to combine the volume of adjacent lockers into a single larger one.

By making lockers adaptable in size, more efficient use of the available volume in landing stations can be achieved. In some embodiments, convertible locker shelves form movable partitions that can divide a very large package locker into two, three or four separate lockers. In some embodiments, individual control of the access doors to these lockers maintains package security.

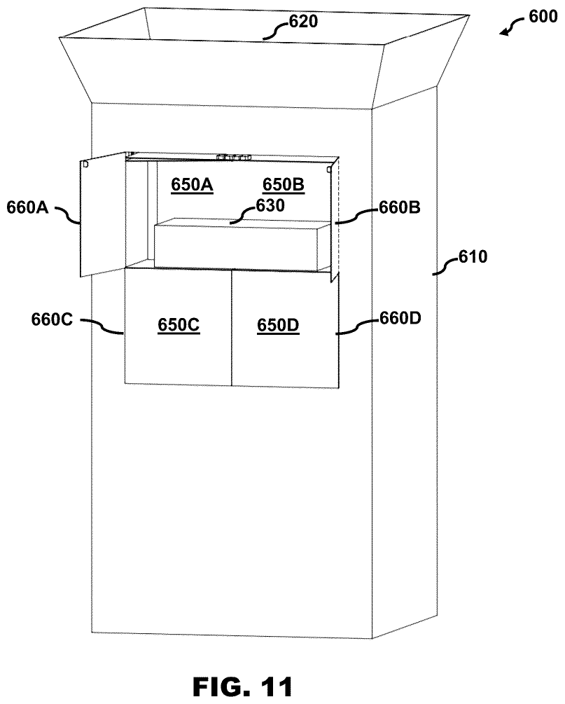

FIG. 11 illustrates a front view of landing station 600 with convertible locker shelves. In some embodiments, landing station 600 includes outer cabinet 610 and landing surface 620 for drones carrying packages to land on. In some embodiments, robotic equipment inside landing station 600 moves package 630 from landing surface 620 to one of four convertible package lockers 650A, 650B, 650C and 650D.

In some embodiments, hinged locker doors 660A, 660B (shown in their open position), and 660C, 660D (shown in their closed position), protect the packages and open under command of a control system when the authorized package recipient arrives.

In some embodiments, two high, two wide clusters of four package lockers 650A, 650B, 650C and 650D are convertible, meaning that the partitions between them can be moved, converting a single locker to a double, triple or quadruple sized locker able to accommodate bigger packages. In FIG. 11, package storage lockers 650A and 650B have been combined into a double wide locker large enough to accept package 630, which is too large to fit in a single locker such as 650D. Had package 630 been too tall for a single package locker such as 650D, two vertically adjacent lockers (for example 650A and 650C) could be combined into a double high locker. Examples of a types of cargo that can take advantage of this capability include a large pizza for a double wide locker, and fresh flowers in a vase for a double high locker. In some embodiments, for packages that are both too tall and wide for a single locker such as 650D, four lockers (650A, 650B, 650C and 650D.) can be combined into a quadruple size locker. This convertible capability allows better balance between the ability to accept an occasional larger package without wasting too much volume inside landing station 600 and reducing the number of standard size package lockers it can support.

In some embodiments, locker doors 660A, 660B, 660C and 660D are coordinated by a control system of landing station 600 to open as required based upon the combination of internal storage lockers currently in effect. In at least some embodiments, this ability simultaneously open the correct combination of multiple locker doors allows for the retrieval of oversize packages through the front of landing station 600.

As illustrated in FIG. 11, package doors 660A and 660B are opened simultaneously when the recipient of double-wide package 630 arrives to collect it. Had the package been double high and stored in locker 650A combined with locker 650C, doors 660A and 660C would have opened. At least in some embodiments, the doors to package lockers not involved in storing an oversize package (650D in our examples above) would not open in response to a package retrieval request, preserving the security of package(s) stored in locker 650D. Retrieval of a quadruple-size package occupying all four package storage lockers would have caused all four doors 660A, 660B, 660C and 660D to open simultaneously. In some embodiments, a higher capacity landing station can have multiple clusters of four package storage lockers each. In some embodiments, various number of lockers can be combined.

In some embodiments, the hinges of the four package locker doors are on the outer vertical edges, as illustrated with the hinges for doors 660A and 660C on the left edge, and hinges for doors 660B and 660D on the right edges. In some embodiments, hinges for the top two lockers can be located on the top, and hinges for the bottom two lockers can be located on the bottom. In some embodiments, the doors swing away from the center of a combined package locker so they do not interfere with removing large packages from the various locker size combinations.

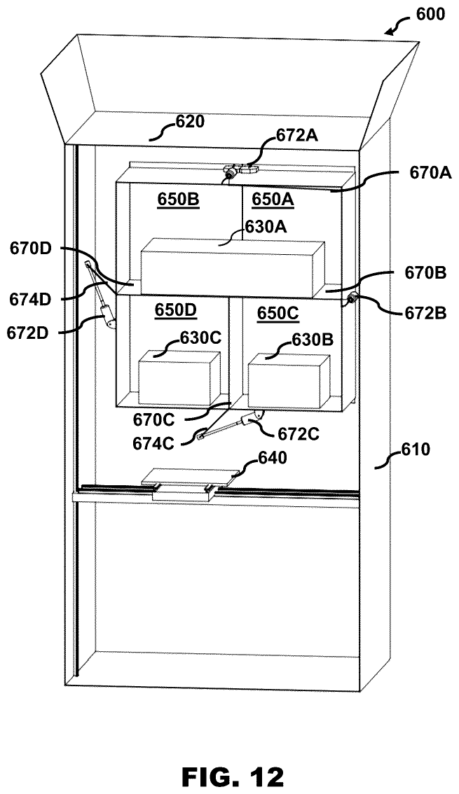

FIG. 12 depicts a rear cross-sectional view according to some embodiments of a landing station 600 with convertible locker shelves. In some embodiments, landing station 600 includes outer cabinet 610, landing surface 620, and convertible package lockers 650A, 650B, 650C and 650D.

In some embodiments, robotic package handling equipment 640 moves packages 630A, 630B and 630C between landing surface 620 and package lockers 650A, 650B, 650C and 650D.

In some embodiments, four movable partition walls 670A, 670B, 670C and 670D extend or retract to convert single size package lockers to double or quad sized locker, under command of a system control processor. In the example configuration shown in FIG. 12, partition wall 670A is retracted by pivoting to be substantially parallel to the top wall of package locker 650A, combining package lockers 650A and 650B into a double wide locker large enough to accommodate wide package 630A. In some embodiments, movable partition walls 670B, 670C and 670D are extended, providing secure walls to separate package lockers 650C and 650D, configuring them to a size able to accept standard size packages 630B and 630C.Two embodiments of actuators to drive movable partition walls 670A, 670B, 670C and 670D are shown in FIG. 12. Rotary actuators 672A and 672B are worm drives or harmonic drives that drive movable partition walls 670A and 670B respectively, enabling them to either extend into the convertible locker storage space to separate lockers, or retract substantially parallel to the outer walls to combine lockers. In some embodiments, linear actuators 672C and 672D, which are leadscrews, belts or rack and pinion systems drive crank arms 674C and 674D to move partition walls 670C and 670D, respectively. In some embodiments, various combinations of these two actuators can be used, depending upon the force and rigidity required, and the space available outside the locker cluster to accommodate the actuators. In some embodiments, sensors associated with actuators 672A, 672B, 672C and 672D monitor the actual position of partition walls 670A, 670B, 670C and 670D, respectively to determine their positions, and to create alarms if they don't achieve the desired position and/or if they are being forced out of position by a package recipient. In some embodiments, the pivoting action of movable partition walls 670A, 670B, 670C and 670D is replaced with rotating, rolling, telescoping or extension motions, driven by appropriate actuators.

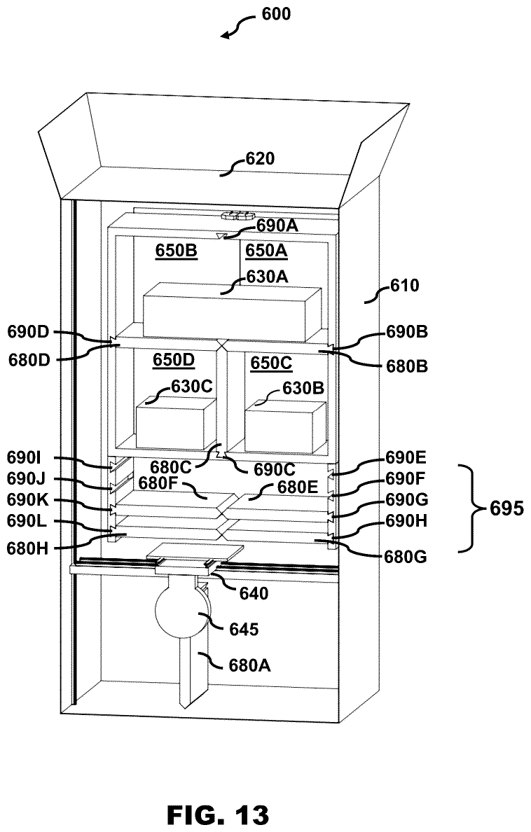

FIG. 13 is a rear cross-sectional view of an embodiment of a landing station 600 with convertible locker shelves. Landing station 600 includes outer cabinet 610, landing surface 620, and convertible package lockers 650A, 650B, 650C and 650D.

In some embodiments, robotic package handling equipment 640 moves packages 630A, 630B and 630C between landing surface 620 and package lockers 650A, 650B, 650C and 650D.

In some embodiments, robotic package handling equipment 640 has a set of partition manipulation actuators 645 that are capable of grasping, moving, orienting, and releasing movable dovetail partitions 680A, 680B, 680C, 680D, 680E, 680F, 680G, 680H. In some embodiments, dovetail partitions 680A-680H are rigid plates with a dovetail feature on their root end that is accepted by a bulkhead wall, and a pointed feature at their opposite end that allows partitions to come together creating a rigid joint between dovetail partitions without interference. In some embodiments, dovetail partitions 680A-680H have thermal insulation, germicidal, enhanced strength and/or security properties. In the example shown in FIG. 13, dovetail partition 680A is being manipulated by the partition manipulation actuators 645 that grasp and rotate in combination with robotic package handling equipment 640 that translates in three dimensions. In some embodiments, these dimensions include raising and lowering the partition vertically, moving it side-to-side, and inserting and/or withdrawing it from dovetails. In some embodiments, the dovetail partitions can be installed in different configurations as walls of convertible package lockers 650A, 650B, 650C and 650D, by sliding them into dovetail positions 690A, 690B, 690C and/or 690D. In some embodiments, when not in use to separate package lockers, the dovetail partitions can be stored in an unused dovetail partition storage magazine 695 by sliding them into dovetails 690E, 690F, 690G, 690H, 690I, 690J, 690K, 690L.

In the example shown in FIG. 13, the convertible package locker is configured to support one double wide package 630A, and two standard size packages 630B and 630C. This configuration is accomplished by inserting dovetail partitions 680B, 680C and 680D into dovetail positions 690B, 690C and 690D, respectively. Notice that no dovetail partition is installed at dovetail position 690A, effectively turning package lockers 650A and 650B into a double wide package locker.

In at least some embodiments, if different combinations of package locker sizes are desired, different combinations of dovetail positions 690A-690D can be filled with partitions. For example, if a quad size package locker is desired combining all four package lockers 650A, 650B, 650C and 650D, all four dovetail positions 690A, 690B, 690C and 690D in the four storage locker cluster would be empty, and dovetail partitions 680A, 680B, 680C and 680D could be stored in dovetail magazine positions 690E, 690F, 690I and 690J until needed again to separate package lockers.

In some embodiments, partition manipulation actuators 645 include a gripper that can securely grasp dovetail partition 680A-680H, and rotate them to the desired orientation. In some embodiments, robotic package handling equipment 640 translates partition manipulation actuators 645 in X, Y and Z dimensions, enabling dovetail partitions such as 680A that have been oriented correctly to be aligned and inserted in combinations of the dovetail positions 690A-690L as desired by the package storage plan established by the control system. In some embodiments, unused dovetail partitions 680E-680H are stored in an unused dovetail partition magazine 695 defined by dovetail positions 690E-690L. In some embodiments, a single unused partition magazine 695 can support multiple clusters of four package lockers served by the same package handling equipment 640 and partition manipulation actuators 645, sourcing or storing dovetail partitions as desired by the system's current package storage configuration. In some embodiments, different types of dovetail partitions desired for different purposes could be stored in the unused dovetail partition magazine 695, for example in some embodiments, dovetail partitions can provide thermal insulation, hermetic sealing, have antimicrobial properties, radio shielding properties, equipment to supply power to stored packages, heating or cooling capabilities, enhanced resistance to forced entry, and/or the like.

While the embodiments shown in FIG. 13 provide a 2×2 cluster of four storage lockers, the system using dovetail partitions 680A-680H can be extended in in the vertical dimension to provide as many convertible package lockers as will fit within outer cabinet 610. In some embodiments, the control system that assigns convertible package locker positions is aware of the specifications of the packages that will be stored in them, and configures the convertible locker accordingly, for example storing the heaviest packages in the lower lockers 650C and 650D in a cluster because their bottom locker walls are fixed, and may have more load bearing capabilities than movable partitions that form the floor of lockers 650A and 650B.

While particular elements, embodiments and applications of the present invention have been shown and described, it will be understood that the invention is not limited thereto since modifications can be made without departing from the scope of the present disclosure, particularly in light of the foregoing teachings.

What is claimed is:

1. A landing station configured to store a package comprising:
a landing surface; and
a first anchor.

2. The landing station of claim 1 wherein said first anchor is retractable.

3. The landing station of claim 1 further comprising:
a lifting ring.

4. The landing station of claim 1 further comprising:
a second anchor;
a third anchor; and
a fourth anchor;
wherein said first anchor is raised and lowered by a first linear actuator, and
wherein said second anchor is raised and lowered by a second linear actuator.

5. The landing station of claim 1 wherein said first anchor is a soil anchor.

6. The landing station of claim 1 wherein said first anchor is a helical anchor.

7. The landing station of claim 1 further comprising:
a sensor configured to determine if said first anchor provides enough force to stabilize said landing station.

8. The landing station of claim 1 wherein said first anchor is lowered by a rotary actuator.

9. The landing station of claim 1 further comprising:
a package manipulation system comprising:
a manipulation rail; and
set of projections configured to raise and lower said package from said landing surface.

10. The landing station of claim 1 further comprising:
a climate control system.

11. The landing station of claim 1 further comprising:
an air curtain blower.

12. The landing station of claim 1 further comprising:
a first locker kept at a first temperature; and
a second locker kept at a second temperature.

13. The landing station of claim 3 further comprising:
a robotic actuator associated with said lifting ring configured to interact with a rigging.

14. The landing station of claim 4 further comprising:
an inertial sensor configured to determine is said landing station is level,
wherein said first linear actuator and said second linear actuator are configured to be automatically reengaged if said inertial sensor determines that said landing station is no longer level.

15. A system for deploying a landing station comprising:
said landing station comprising:
a landing surface;
a lifting ring; and
a first retractable anchor; and
an installation vehicle.

16. The system of claim 15 wherein said installation vehicle is a heavy-lift aerial vehicle

17. The system of claim 15 wherein said installation vehicle is a mobile crane.

18. The system of claim 15 wherein said installation vehicle is a crane-equipped seagoing barge.

19. The system of claim 15 wherein said landing station further comprises:
a robotic actuator associated with said lifting ring configured to interact with a rigging of said installation vehicle.

20. The system of claim 15 wherein said landing station further comprises:
a second retractable anchor;
a third retractable anchor; and
a fourth retractable anchor;
wherein said first retractable anchor is raised and lowered by a first linear actuator, and
wherein said retractable second anchor is raised and lowered by a second linear actuator.
